(19) United States
(12) Patent Application Publication
(10) Pub. No.: US 2024/0141115 A1
(43) Pub. Date: May 2, 2024

(54) FAST HYDRATING POLYACRYLAMIDE MICROPLATES

(71) Applicant: SOLENIS TECHNOLOGIES, L.P., Wilmington, DE (US)

(72) Inventor: Leo Zhaoqing Liu, Newark, DE (US)

(73) Assignee: SOLENIS TECHNOLOGIES, L.P., Wilmington, DE (US)

(21) Appl. No.: 18/500,477

(22) Filed: Nov. 2, 2023

Related U.S. Application Data
(60) Provisional application No. 63/381,940, filed on Nov. 2, 2022.

(51) Int. Cl. C08J 3/12; C08J 7/06

(52) U.S. Cl. CPC C08J 3/128; C08J 7/06; C08J 2333/26

(57) ABSTRACT

A fast-hydrating polyacrylamide solid in the shape of microplates is provided and the process to make the microplates. The microplates can be treated with any processing and/or functional substances to facilitate the dissolution process or/and to import functional properties to the said solid.

This application claims the benefit of U.S. Provisional application No. 63/381,940, filed 2 Nov. 2022, the entire contents of which are hereby incorporated by reference.

### TECHNICAL FIELD

The present disclosure generally relates to a fast-hydrating polyacrylamide solid in the shape of microplates and the process to make the microplates. The microplates can comprise or be treated with any processing aids or/and functional substances to facilitate the preparation of the microplates as well as their dissolution in water or/and to import functional properties to the said solid.

### BACKGROUND

Polyacrylamide products are produced in solid, beads, aqueous solution, aqueous dispersion, and inverse emulsion. The aqueous solution or dispersion is limited to low active or/and products of low molecular weight. The water/oil inverse emulsion could achieve active as high as 45?, it utilizes VOC solvents.

Although polyacrylamide micro-beads are solid and of high active, the process efficiency is lower, and the polymerization reaction takes place at about 20% active monomer/polymer in a VOC solvent which has to be purified and recycled. The solid obtained by gel polymerization is considered the most sustainable process of choice. The high active products, usually at 30 to 40% active monomer/polymer, are produced in gel form, grinded, and dried continuously. However, hydration of rough grinded powder, usually at 0.5-1.5 mm size of wide particle size distribution, takes tens of minutes up to hours to complete. The long hydration time limits its use in a wider array of applications such as oil fields. Therefore, short hydration times are needed for almost all of its uses to save time, space, and capital cost of equipment.

Traditionally, fine grinding to less than 200 nm to produce powder of narrower particle size distribution has been used for short hydration times of less than 30 minutes with specially designed make-down equipment to avoid agglomeration or “fish-eyes” formation. As an alternative to avoid agglomeration, the fine powder can also be dispersed in an organic solvent and then hydrated. The grinding process is energy intensive, and it needs air or liquid nitrogen cooling. The process generates a lot of dust. Often the molecular weight, thus the performance, is reduced during mechanic processing. Organic solvent has to be used to make polyacrylamide powder dispersions.

### BRIEF SUMMARY

What is disclosed is a polyacrylamide microplate(s) comprising a polyacrylamide polymer and having a thickness of about 10 microns to 1000 microns and a surface dimension of about 300 to about 3000 microns.

Also disclosed is a method of producing polyacrylamide microplate(s) comprising providing a polyacrylamide gel and forming a gel film or gel flakes by extruding, pressing, stretching, and/or blowing the polyacrylamide gel, to a thickness of about 50 microns to about 3000 microns, or 80 microns to 2000 microns. The film or flakes can then be dried and ground to form polyacrylamide microplate(s) of more uniform in thickness.

The use of the polyacrylamide microplate(s) in water-treatment, mining, petroleum exploration and recovery processes is also provided below.

### BRIEF DESCRIPTION OF THE DRAWINGS

FIG. 1, is a graph showing viscosity of 0.5% Praestol 2530KF-NC in water with or without starch lamination.

FIG. 2, is a graph of the storage modulus of 0.5% Praestol 2530KF-NC in water with and without Starch Lamination.

FIG. 3, is a graph of the loss of modulus of 0.5% Praestol 2530KF-NC in water with and without starch lamination.

### DETAILED DESCRIPTION

The following detailed description is merely exemplary in nature and is not intended to limit the invention or the application and uses of the invention. Unless specifically stated or obvious from context, as used herein, the term “about” is understood as within a range of normal tolerance in the art, for example within 2 standard deviations of the mean. “About” can be understood as within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

Disclosed is a process based on gel polymerization to make high active polyacrylamide with a fast hydration rate. In particular, disclosed is a polyacrylamide microplate(s) comprising an acrylamide-bearing polymer, having a thickness of about 10 microns to 1000 microns and a flat surface dimension of about 300 to about 3000 microns and can have a thickness of about 30 microns to 300 microns and a flat surface dimension of about 400 to about 1000 microns wherein the thickness of the microplate(s) is more uniformly defined than the flat surface sizes, which can vary in any plane shapes and in wider distribution of sizes.

In some aspects of the microplate(s), the polyacrylamide polymer comprises anionic, cationic, amphoteric, or non-ionic monomers in addition to acrylamide.

In some aspects of the polyacrylamide microplate(s), the microplate(s) contains a processing aid and/or functional substance. The processing aids and/or functional substances can be incorporated in the polyacrylamide polymer formulation, or they can be disposed on the surface of the microplate(s). The processing aids and/or functional substances can be chosen from anti-blocking agents, free-flowing agents, anti-caking agents, disintegrants and wetting agents, corrosion inhibitors, shale inhibitors, foaming agents, antimicrobial agents, coagulants, anti-foaming agents, dispersants, scale inhibitors or combinations thereof.

In some aspects of the polyacrylamide microplate(s), the processing aids and/or functional substances can be laminated with the polyacrylamide. As such polyacrylamide is sandwiched in between the laminating substance, wherein the processing aids and/or functional substances turn into laminating substance.

In some aspects, polyacrylamide is laminated with the laminating substance in multiple layers. The laminating substance can be in a liquid or a powder form. Laminating substances can be any hydrophobic oils or lubricants, non-ionic surfactants with a cloud point lower than the lamination temperature and/or polymers possessing a lower critical solubility temperature than the lamination temperature.

In other aspects of the laminating substance, the laminating substance can be a powder chosen from super-absorbents, talc, clay, halloysite, silica/silicate, starch, food flours of raw grains, roots, beans, nuts, seeds, or combinations thereof.

In some aspects of the polyacrylamide microplate(s), the laminating substance can be disposed on the microplate(s) in layers of thickness which is deemed acceptable for processing or for functional properties. The laminating layers can be more or less than that the polyacrylamide layers once the laminating substance forms its separate phase.

Also provided is a method of producing polyacrylamide microplate(s), wherein a polyacrylamide polymer gel is extruded, pressed, stretched, and/or blown forming a gel film or gel flakes having a thickness of about 50 microns to about 3000 microns, or about 100 to about 400 microns. The gel film or flakes can then be dried and ground forming the microplate(s) of more uniformly defined thickness than the flat dimensions, which can be any plane shapes and sizes of wider distribution. It will be understood that the gel has water and can be pressed, whereas the microplate(s) is a solid, which can be ground, but cannot be pressed to a thinner thickness.

In some aspects of the method, the gel film or gel flakes can have a thickness of about 80 microns to about 2000 micron, or from about 100 microns to about 1000 microns. One can normally make precise film thickness within at least 20% relative errors. However, typical grinding can result in dimensions of large sizes, which is 10 to 100 times of small ones.

In some aspects of the method, the polyacrylamide gel is formed by polymerization in-situ in the presence of acrylamide monomer during extrusion and/or film processing.

In some aspects of the method, the polyacrylamide film is formed directly from substances compromising acrylamide.

In other aspects of the method, the step of grinding is further defined as grinding the dried polyacrylamide film or flakes to form microplate(s) having a thickness of about 30 microns to about 300 microns and a flat surface dimension of about 400 to about 1000 microns. Given the uniform thickness, each polyacrylamide microplates would hydrate evenly among all particles since water takes the shortest and uniform pass to dissolve the particles. Unlike the two-dimensional plates, the fine-ground powder as presently disclosed will have small particles dissolve rapidly and then stick onto large particles if not under high shear while the dissolution time is determined by the larger particles.

In yet other aspects of the method, the microplate(s) has a thickness of about 10 microns to 1000 microns and a flat surface dimension of about 300 to about 3000 microns, or a thickness of about 40 microns to 300 microns and a flat surface dimension of about 400 to about 1000 microns.

In some aspects of the method, one or more processing aids and/or functional substances can be applied to the polyacrylamide polymer gel, gel film or gel flakes. It is understood that the processing aids and functional substances can be added to the bulk not just on the surfaces of the gel or film or microplates.

In some aspects of the method, the processing aids and/or functional substances are chosen from anti-blocking agents, free-flowing agents, anti-caking agents, disintegrants, wetting agents, corrosion inhibitors, shale inhibitors, foaming agents, antimicrobial agents, coagulants, anti-foaming agents, dispersants, scale inhibitors, or combinations thereof.

In some aspects of the method, a laminating substance is disposed on the surface of the polyacrylamide gel, gel film or flakes or the microplate(s) to have single layer of polyacrylamide coated or laminated. A laminating substance is disposed on the surface of the polyacrylamide film or the microplate(s).

In yet other aspects of the method, the laminated film, or flakes of greater than two layers of polyacrylamide are formed by pressing, air-blowing, or stretching two or more layers of the coated single layer of polyacrylamide gel. The laminating substances used in the studies were selected to prevent polyacrylamide sheets or film from sticking together and/or serving as mechanically weak bonding layers, which can be delaminated upon drying, grinding, or dissolution of the extruded gel so as to create a larger surface area for the microplate(s) to hydrate.

In some aspects of the current method, the laminating substances can be liquid or fine powder, so long as they modify the gel surface for successful lamination and then serve to delaminate the polymer layer during drying, grinding, storage or hydration.

In other aspects of the method, the liquid laminating substance is soluble in water at polyacrylamide application temperature, usually ambient temperature, so the liquid will not inhibit the polymer hydration, but is insoluble in a polyacrylamide gel phase during lamination with polyacrylamide gel. The liquid can also be insoluble in gel or in water so long as the liquid will be detached upon contact of the microplates with water. Examples includes non-ionic surfactants with cloudy point lower than lamination temperature, and polymer possessing lower critical solubility temperature of less than lamination temperature, non-volatile hydrophobic oil, or lubricant such as mineral oils and ester oils of high flash and high boiling point.

In some aspects, a fine powder includes those used as disintegrants or anti-blocking agent, such as super-absorbents, talc, clay, halloysite, silicalsilicate, starch, food flours of raw grains, roots, beans, nuts, and/or seeds.

In yet other aspects of the method, the laminating substances can also be made to chemically modify polyacrylamide during the process so as to enhance the polymer application performance. Chemical modification could also be carried with the laminating materials to enhance their solubility in water or to impart properties for the targeting applications where the polyacrylamide is intended.

In one aspect of the current method, the laminating can be a starch. Native starch is not cold water soluble or swellable and the starch granules vary in size from less than 1 μm to more than 100 μm. Starch can be treated and/or roasted into cold water soluble and/or swellable granular starch, dextrins or dextrose. Starch can also be chemically modified during the lamination and drying processing to make it more water-soluble or/and to add functionality for targeting applications where polyacrylamide products are used. For example, to add cationic or anionic functionality through etherification. Starch can be chemically attached to polyacrylamide to enhance the product performance. Therefore, starch is not only serving as laminating substances to make fast-hydrating polyacrylamide products, but also boosting the product functional properties such as rheological modifiers for oil drilling and simulation, chemical enhanced oil recovery, metal corrosion inhibitor, soluble-iron removal agent in oil & gas, coagulants and/or flocculants for mining, water and wastewater treatment, strength agent in paper-making process, for example.

In some aspects of the method, a laminating substance is disposed on the surface of the polyacrylamide gel, gel film or flakes or the microplate(s) to have single layer of polyacrylamide coated or laminated.

In yet other aspects of the method, a laminated polyacrylamide film or flakes having two or more layers can be further extruded, pressed, air-blown and/or stretched to form a laminate with layers of polyacrylamide film or flakes having a thickness from about 1 micron to about 3,000 microns.

Also provided is the use of the polyacrylamide microplate(s) as described above in water-treating, mining, petroleum exploration and recovery. In addition, the fast-hydrating polyacrylamide can serve as dry strength additive as well as retention and drainage aid.

### EXAMPLES

### Example 1

Polyacrylamide gel of 30% active solid content was prepared by photo-initiated polymerization using 331.46 parts 50% acrylamide, 103.80 parts acrylic acid neutralized with 109.60 parts of 50% caustic soda in 443.50 parts water. Initiators and additives used for gel polymerization to form gel blocks. The gel blocks with added processing aids were grinded in a meat grinder to make polyacrylamide gel particles.

Cornstarch, was treated with an alkaline alcohol solution by mixing 102.97 parts cornstarch and 39:39 parts of 8:2 ethanol/15% sodium hydroxide. Using 163.03 parts of the ground polyacrylamide gel bits, the ground particles were coated with 35.97 parts of the treated starch. The coated polyacrylamide particles were sieved through a ¼-inch sieve. Each time, 20-30 grams of the coated polymer particles were placed between two aluminum foils and pressed under a 12-inch by 12-inch heated hydraulic press at about 65° C. and 10,000 lb. force to fount a pressed sheet. The rest of the treated starch was applied as a coating on the surface of the pressed sheets. The coated sheets were folded and pressed a second time and coated again to multiple layers of laminated polyacrylamide gel. The sheets were then dried at 120° C. for 10 min, followed by 100° C. for 20 min and 90° C. for 20 min. The dried sheets were milled and sieved through a 425-micron sieve and retained by a 170-micron sieve.

### Example 2

The same procedure followed in Example 1, was used in this example except that the dried sample was sieved only through a 425-micron sieve and not a 170-micron sieve.

### Example 3—Comparable

The ground polymer gel from example 1, was dried directly without lamination with starch, milled and sieved through 425-micron sieve and retained by 170-micron sieve

### Example 4—Comparable

Ground polymer gel from example 3, was used in this example except that the dried sample was sieved only through a 425-micron sieve and not a 170-micron sieve.

### Example 5

A study on the rate of hydration of a solution of about 0.1-0.2% active polyacrylamide was done using tap water. The samples obtained from Examples 1˜4 were mixed in water with an overhead mixer, Samples were taken at the set time intervals and the viscosities were measured immediately using a Brookfield viscometer. Examples 1-2 demonstrated faster hydration which ended within 5 minutes while the control takes 2 to 3 times longer to totally hydrate in water to reach constant viscosity.

TABLE 1
Brookfield Viscosity (centipoise (cps))

| | Time (Min.) | | | | | | | |
|---|---|---|---|---|---|---|---|---|
| | 3 | 5 | 7 | 8 | 10 | 15 | 20 | 25 |
| Ex. 1* | 26.4 | 34.8 | | 34.8 | 34.8 | 34.8 | | |
| Ex. 2** | 30.6 | 39.0 | 39 | | 39 | | | |
| Ex. 3*** | | 12.0 | | | 25.2 | 33 | 34.8 | 36.6 |
| Ex. 4**** | 13.2 | 18.0 | | | 18.6 | 18.8 | 19.2 | |

*Ex 1, 0.2%, 170-425 μm
**Ex 2, 0.2%, <425 μm
***Comp. Ex 3, 0.1%, 170-425 μm
****Comp. Ex 4, 0.1%, <425 μm

### Example 6

The ground polyacrylamide gel particles prepared in Example 1, were used in this example. A 100-gram sample of the ground polyacrylamide gel was coated with 30 grams of the treated starch as disclosed in Example 1 and passed through a ¼-inch sieve. Each time this was done, 15 to 18 grams of such coated gel particles were collected and pressed into thin sheets between two non-sticky coated metal cooking sheets using the heated hydraulic press as described in Example 1. The pressed thin sheets were then brush-coated with 3.3 grams of the treated starch to render the surface of the pressed sheets non-sticky. The coated sheets were dried in an oven at 90° C. for 30 min, ground and then sieved through a 425-micron sieve.

### Example 7

The same procedure as used in Example 5, was used to examine the hydration of products obtained from Example 2, 4 and 6. The results demonstrate that the two-dimensional microplates had two to three times faster hydration than the comparative examples of the comparable sizes. In addition, a single press was found to be enough to have the gel dry faster at a lower temperature and to hydrate faster (Table 2). Also noted starch could also boost the viscosity of the aqueous solution.

TABLE 2
Brookfield Viscosity (centipoise (cps))

| | Time (Min.) | | | | | | |
|---|---|---|---|---|---|---|---|
| | 3 | 5 | 6 | 7 | 10 | 15 | 20 |
| Ex. 2* | 30.6 | 39 | | 39 | 39 | | |
| Ex. 6** | 27 | 30.6 | | 30.6 | 30.6 | | |
| Ex. 4*** | 13.8 | | 16.8 | | 18 | 19.2 | 19.2 |
| Ex. 4**** | 18.0 | 27 | | | 30.6 | 31.8 | 31.8 |

*Ex 2, 0.2%, <425 μm
**Ex 6, 0.17%, <425 μm
***Comp. Ex 4, 0.1%, <425 μm
****Comp. Ex 4, 0.13%, <425 μm

### Example 8

A ground anionic polyacrylamide gel intermediate, Praestol™ 2530KF-NC, from Solenis, LLC was used in this example. An 81.33-gram sample of the ground Praestol” 2530KF-NC wet gel (30% active solid), was coated with 4.12 grams untreated cornstarch and pressed as described in Example 6, but at 20,000 lb. force. The resulting wet thin flakes were brush coated with 2.1 grams of untreated starch, dried at 90° C. for 30 minutes and then 80° C. for 10 minutes, and ground in a coffee grinder. The resulting powder was then sieved through a 425-micron sieve.

### Example 9

The same procedure used in Example 8 was used in this example, except 88.04 grains of the ground polyacrylamide gel intermediate from Praestol™ 2530 KF-NC, was used with non-treated cornstarch at 8.96 grams as gel coating and 1.57 grams as film coating.

### Example 10—Comparative

Commercial product of Praestol™ 2350KF-NC granules was sieved through 425-micron sieve to obtain the three-dimensional particles.

### Example 11—Comparative

Praestol™ 2530KF-NC granules were ground on a commercial air classifier mill to particles having a D90/D50 of 167/106 microns by light diffraction.

### Example 12

The same procedure used in Example 5 was used here, to compare the hydration rate of products coming from Examples 8-11. The results are shown in Table 3. The starched Praestol™ 2530KF-NC did reveal a high Brookfield viscosity at the same active polyacrylamide levels as samples with no starch treatment. The thinner microplates of Examples 8 and 9 were hydrated faster than the comparative three dimensional particles (Example 10) and comparatively with the fine ground powder (Example 11).

TABLE 3
Brookfield Viscosity (centipoise (cps))

| | Time (Min.) | | | | | | | |
|---|---|---|---|---|---|---|---|---|
| | 3 | 5 | 7 | 8 | 10 | 15 | 20 | 25 |
| Ex. 8* | 32.5 | 36.3 | 37.3 | | 37.6 | 37.6 | | |
| Ex. 9** | 24.2 | 29.6 | | 32.6 | 33.5 | 33.8 | | |
| Ex. 10*** | 20.7 | 26.7 | | | 28.4 | 29 | 29.1 | 29.2 |
| Ex. 11**** | 24 | 27 | 27.5 | | 28.1 | 29 | | |

*Ex 8, 0.2%, <425 μm
**Ex 9, 0.2%, <425 μm
***Comp. Ex 10, 0.15%, < 425 μm
****Comp. Ex 11, 0.15%, D90/D50, 167/106 μm

### Example 13

Samples from Example 9 and comparative Example 11, were studied for solution elasticity using a TA Instruments OHR-II stress rheometer. A solution of 0.5% active polymer was prepared in distilled water and mixed with 8000 ppm brine of sodium and calcium chloride salts. The starched Praestol™ 2350KF-NC from Example 9 was dissolved in fresh water at 0.666% as is while the comparative at 0.50%. The aqueous solutions were submitted for rheology analysis and the same solution were analyzed again with addition of more concentrated brine made from sodium and calcium chlorides at 8000 ppm by weight.

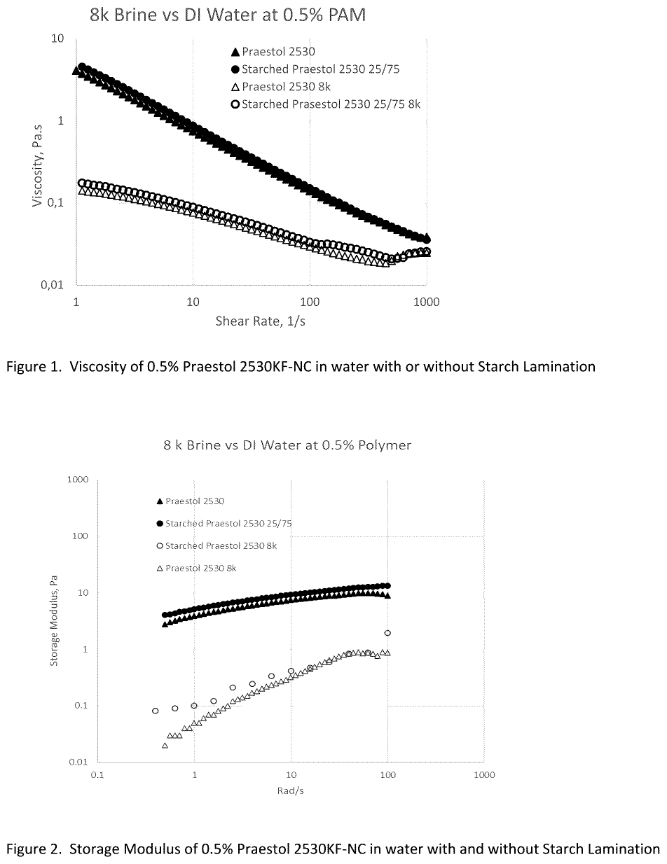

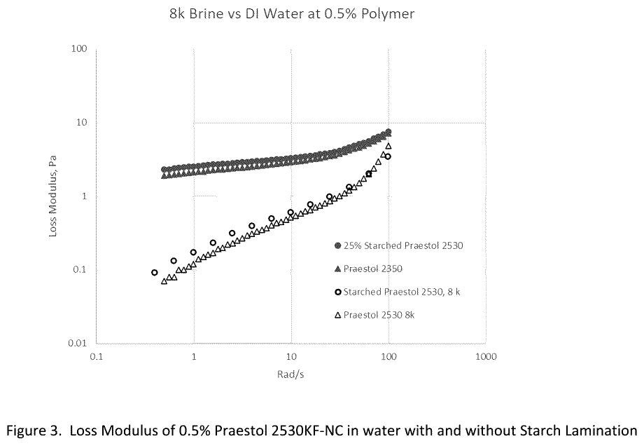

Starch not only made Praestol™ 2530 KF-NC hydrate in water faster, but also contributed to the viscosity of the aqueous solution with or without the presence of electrolyte (see FIG. 1 and FIG. 3) and enhanced the solution elasticity (see FIG. 2), a key attribute needed for chemical enhanced oil recovery.

What is claimed is:

1. A polyacrylamide microplate(s) comprising a polyacrylamide polymer and having a thickness of about 10 microns to 1000 microns and a flat surface dimension of about 200 to about 3000 microns.

2. The polyacrylamide microplate(s) according to claim 1, wherein the microplate(s) has a thickness of about 30 microns to 300 microns and a flat surface dimension of about 300 to about 1000 microns, and wherein the thickness is more uniformly shaped forming a gel film while the flat surface dimensions vary in shapes and sizes.

3. The polyacrylamide microplate(s) according to claim 1, wherein the polyacrylamide polymer comprises anionic, cationic, amphoteric, or non-ionic polymer containing acrylamide monomer(s).

4. The polyacrylamide microplate(s) according to claim 1, further comprising processing aids and/or functional substances chosen from anti-blocking agents, free-flowing agents, anti-caking agents, disintegrants and wetting agents, corrosion inhibitors, shale inhibitors, foaming agents, antimicrobial agents, coagulants, anti-foaming agents, dispersants, scale inhibitors, lubricants, and combinations thereof.

5. The polyacrylamide microplate(s) according to claim 4, wherein the processing aids and/or functional substances can be disposed on the surface of the microplate(s).

6. The polyacrylamide microplate(s) according to claim 4, wherein the polyacrylamide microplate(s) is laminated with the processing aids and/or functional substances in one or more layers of polyacrylamide.

7. The polyacrylamide microplate(s) according to claim 4, wherein the processing aids and/or functional substances are liquids chosen from non-ionic surfactants with a cloud point lower than the lamination temperature, polymers possessing a lower critical solubility temperature that is less than the lamination temperature, hydrophobic oils, and combinations thereof.

8. A method of producing polyacrylamide microplate(s) comprising providing a polyacrylamide gel;
forming a gel film or gel flakes by extruding, pressing, stretching, and/or blowing the polyacrylamide gel, to a thickness of about 50 microns to about 3000 microns;
drying and grinding the film or flakes to form the polyacrylamide microplate(s).

9. The method according to claim 8, wherein the extruding, pressing, stretching, and/or blowing step is further defined as forming a gel film or gel flakes having a thickness of about 80 microns to about 2000 micron.

10. The method according to claim 9, wherein the polyacrylamide gel is formed by polymerization in-situ in the presence of acrylamide monomer during extrusion and/or film processing.

11. The method according to claim 8, wherein the polyacrylamide film or flakes is formed by polymeric substances compromising acrylamide.

12. The method according to claim 8, wherein the step of grinding is further defined as grinding the dried polyacrylamide film or flakes to form microplate(s) having a thickness of about 10 microns to about 1000 microns and a surface dimension of about 200 to about 3000 microns, wherein the thickness is more uniformly shaped from gel film while the flat surface dimensions vary in shapes and sizes based on the degree of grinding.

13. The method according to claim 12, wherein the microplate(s) has a thickness of about 20 microns to 500 microns and a flat surface dimension of about 250 to about 2000 microns wherein the thickness is more uniformly shaped from gel film while the flat surface dimensions vary in shapes and sizes based on the degree of grinding.

14. The method according to claim 8, further comprising applying one or more processing aids and/or functional substances to the surface of the polyacrylamide gel or/and gel film or flakes.

15. The method according to claim 14, wherein the one or more processing aids and/or functional substances are chosen from anti-blocking agents, free-flowing agents, anti-caking agents, disintegrants, wetting agents, corrosion inhibitors, shale inhibitors, foaming agents, antimicrobial agents, coagulants, anti-foaming agents, dispersants, scale inhibitors, or combinations thereof.

16. The method according to claim 8, wherein a laminating substance is disposed on the surface of the polyacrylamide gel, gel film or flakes, or the microplate(s) forming a single coated or laminated layer on the polyacrylamide.

17. The method according to claim 16, wherein a laminated film or flakes having more than one layer of polyacrylamide is formed and by pressing, air-blowing, or stretching have a thickness from about 1 micron to about 3,000 microns.

18. The method according to claim 17, wherein the more than one laminated film or microplate(s) is pressed, air-blown, or stretched to a thickness of from about 10 microns to about 1000 microns.

19. The method according to claim 16, wherein the microplate(s) are laminated with a powder chosen from super-absorbents, talc, clay, halloysite, silica/silicate, starch, food flours of raw grains, roots, beans, nuts, seeds, or combinations thereof.

20. Use of the polyacrylamide microplate(s) according to claim 1, in water-treatment, mining, petroleum exploration and recovery processes.
